(19) United States
(12) Patent Application Publication
(10) Pub. No.: US 2025/0050435 A1
(43) Pub. Date: Feb. 13, 2025

(54) TOOL FOR CUTTING AND PLUGGING A FLUID LINE

(71) Applicant: Niez Tech LLC, Brewster, MA (US)

(72) Inventors: Brian Niezgoda, Brewster, MA (US); Dean Niezgoda, Brewster, MA (US)

(21) Appl. No.: 18/446,515

(22) Filed: Aug. 9, 2023

(51) Int. Cl. B23D 21/00; B23D 21/10; F16L 55/11

(52) U.S. Cl. CPC B23D 21/006; B23D 21/10; F16L 55/11

(57) ABSTRACT

A service tool for cutting and plugging a fluid line includes a body having a receiving portion configured to receive the fluid line, a clamping mechanism movable relative to the body and configured to clamp around at least a portion of an outer circumference of the fluid line when the fluid line is received in the receiving portion, and a cutting blade configured to engage the fluid line and cut the fluid line into a first cut portion and a second cut portion. The service tool further includes a hub associated with the body, the hub including a plugging mechanism configured to dispense a plug or a valve into the second cut portion of the fluid line.

### BACKGROUND

### Technical Field

The present disclosure relates to a service tool for servicing a fluid line. More specifically, the present disclosure relates to a service tool for cutting and plugging a fluid line.

### Technical Considerations

Fluid lines, such as water supply lines, require periodic servicing or repair that require an upstream portion of the fluid line to be isolated from a downstream fluid line so that service or repair can be made. Typically, water is turned off at a point upstream of the location where service or repair is necessary to allow the fluid line to be cut. This results in an inconvenience until the service or repair is completed.

There exists a need in the art for a service tool for servicing a fluid line without the need for turning off the upstream water supply.

### SUMMARY

In some non-limiting embodiments or aspects of the present disclosure, provided is a service tool for cutting and plugging a fluid line. The service tool may include a body having a receiving portion configured to receive the fluid line; a clamping mechanism movable relative to the body and configured to clamp around at least a portion of an outer circumference of the fluid line when the fluid line is received in the receiving portion; a cutting blade configured to engage the fluid line and cut the fluid line into a first cut portion and a second cut portion; and a hub associated with the body. The hub may include a plugging mechanism configured to dispense a plug or a valve into the second cut portion of the fluid line.

In some non-limiting embodiments or aspects of the present disclosure, the cutting blade may be configured to cut the fluid line into the first cut portion and the second cut portion via a rotational movement of the cutting blade relative to the body about a cutting axis, via a translational movement of the cutting blade relative to the body, via a rotational movement of the cutting blade relative to the fluid line about a cutting axis, and/or via a reciprocal linear movement of the cutting blade relative to the fluid line.

In some non-limiting embodiments or aspects of the present disclosure, the clamping mechanism may include at least one jaw movable relative to the body between an open position and a closed position. In the closed position, the at least one jaw may be configured to clamp around at least the portion of the outer circumference of the fluid line. The at least one jaw may be removably connectable to the body via a connecting element.

In some non-limiting embodiments or aspects of the present disclosure, a handle may be connected to the body. The handle may extend in a direction substantially perpendicular to a longitudinal axis of the receiving portion.

In some non-limiting embodiments or aspects of the present disclosure, the hub may be rotatable relative to the body about a pivot point. The hub may be translatable relative to the body via an engagement mechanism. The engagement mechanism may be a threaded bolt, a spring, or a lever.

In some non-limiting embodiments or aspects of the present disclosure, an input drive may be configured to move the cutting blade relative to the body. The input drive may be a keyed drive configured for receiving a corresponding input tool.

In some non-limiting embodiments or aspects of the present disclosure, hub may be configured to contact the fluid line as the cutting blade is rotated about the cutting axis or translated relative to the body to displace the first cut portion of the fluid line such that the plug chamber is aligned with the second cut portion of the fluid line. In some non-limiting embodiments or aspects of the present disclosure, the plugging mechanism may include a plug chamber configured to receive the plug or the valve. The plug or the valve may be disposed in the plug chamber of the plugging mechanism. The plug or the valve may be threadably or slidably received within the plug chamber.

In some non-limiting embodiments or aspects of the present disclosure, the plug may include an inner portion having a plug end with a seal configured for engaging an inner sidewall of the second cut portion of the fluid line and an outer portion threadably connected to a shaft of the inner portion protruding from the plug end. The outer portion may have first threads on an interior thereof configured for threadably connecting to the shaft of the inner portion and second threads on an exterior thereof for threadably connecting to the plug chamber of the plug mechanism.

Additional embodiments or aspects of the improved service tool are detailed in one or more of the following clauses:

Clause 1: A service tool for cutting and plugging a fluid line, the service tool comprising: a body having a receiving portion configured to receive the fluid line;
a clamping mechanism movable relative to the body and configured to clamp around at least a portion of an outer circumference of the fluid line when the fluid line is received in the receiving portion; a cutting blade configured to engage the fluid line and cut the fluid line into a first cut portion and a second cut portion; and a hub associated with the body, the hub comprising a plugging mechanism configured to dispense a plug or a valve into the second cut portion of the fluid line.

Clause 2: The service tool according to clause 1, wherein the cutting blade is configured to cut the fluid line into the first cut portion and the second cut portion via a rotational movement of the cutting blade relative to the body about a cutting axis.

Clause 3: The service tool according to clause 1 or 2, wherein the cutting blade is configured to cut the fluid line into the first cut portion and the second cut portion via a translational movement of the cutting blade relative to the body.

Clause 4 The service tool according to any one of clauses 1 to 3, wherein the cutting blade is configured to cut the fluid line into the first cut portion and the second cut portion via a rotational movement of the cutting blade relative to the fluid line about a cutting axis.

Clause 5: The service tool according to any one of clauses 1 to 4, wherein the cutting blade is configured to cut the fluid line into the first cut portion and the second cut portion via a reciprocal linear movement of the cutting blade relative to the fluid line.

Clause 6: The service tool according to any one of clauses 1 to 5, wherein the clamping mechanism comprises at least one jaw movable relative to the body between an open position and a closed position.

Clause 7: The service tool according to any one of clauses 1 to 6, wherein, in the closed position, the at least one jaw is configured to clamp around at least the portion of the outer circumference of the fluid line.

Clause 8: The service tool according to any one of clauses 1 to 7, wherein the at least one jaw is removably connectable to the body via a connecting element.

Clause 9: The service tool according to any one of clauses 1 to 8, further comprising a handle connected to the body, wherein the handle extends in a direction substantially perpendicular to a longitudinal axis of the receiving portion.

Clause 10: The service tool according to any one of clauses 1 to 9, wherein the hub is rotatable relative to the body about a pivot point (axis of rotation?).

Clause 11: The service tool according to any one of clauses 1 to 10, wherein the hub is translatable relative to the body via an engagement mechanism.

Clause 12: The service tool according to any one of clauses 1 to 11, wherein the engagement mechanism is a threaded bolt, a spring, or a lever.

Clause 13: The service tool according to any one of clauses 1 to 12, further comprising an input drive configured to move the cutting blade relative to the body.

Clause 14: The service tool according to any one of clauses 1 to 13, wherein the input drive is a keyed drive configured for receiving a corresponding input tool.

Clause 15: The service tool according to any one of clauses 1 to 14, wherein the hub is configured to contact the fluid line as the cutting blade is rotated about the cutting axis or translated relative to the body to displace the first cut portion of the fluid line such that the plug chamber is aligned with the second cut portion of the fluid line.

Clause 16: The service tool according to any one of clauses 1 to 15, wherein the plugging mechanism comprises a plug chamber configured to receive the plug or the valve.

Clause 17: The service tool according to any one of clauses 1 to 16, further comprising the plug or the valve disposed in the plug chamber of the plugging mechanism.

Clause 18: The service tool according to any one of clauses 1 to 17, wherein the plug or the valve is threadably or slidably received within the plug chamber.

Clause 19: The service tool according to any one of clauses 1 to 18, wherein the plug comprises an inner portion having a plug end with a seal configured for engaging an inner sidewall of the second cut portion of the fluid line and an outer portion threadably connected to a shaft of the inner portion protruding from the plug end.

Clause 20: The service tool according to any one of clauses 1 to 19, wherein the outer portion has first threads on an interior thereof configured for threadably connecting to the shaft of the inner portion and second threads on an exterior thereof for threadably connecting to the plug chamber of the plug mechanism.

### BRIEF DESCRIPTION OF THE DRAWINGS

Additional advantages and details are explained in greater detail below with reference to the exemplary embodiments that are illustrated in the accompanying figures, in which:

FIG. 1 is a right side view of a service tool for cutting and plugging a fluid line in accordance with one embodiment or aspect of the present disclosure;

FIG. 2 is a left side view of the service tool shown in FIG. 1;

FIG. 3 is an exploded perspective view of the service tool shown in FIG. 1;

FIG. 4 is a side view of a cutting blade for use with the service tool shown in FIG. 1;

FIG. 5 is a cross-sectional view of the service tool shown in FIG. 1 taken along line A-A;

FIG. 6 is a perspective view of the service tool of FIG. 1 showing an installation of a plug;

FIG. 7 is a left side view of the service tool of FIG. 1 with jaws of the service tool shown in an open position;

FIG. 8 is a left-side perspective view of the service tool of FIG. 1 shown on a utility line;

FIG. 9 is a right-side perspective view of the service tool of FIG. 1 shown in a start of cut position on a utility line;

FIGS. 10-13 are side cross-sectional views of the service tool of FIG. 1 showing the position of the cutting blade at various positions relative to a utility line;

FIG. 14 is a right-side perspective view of the service tool of FIG. 1 showing a cut utility line and a plug in an uninstalled position;

FIG. 15 is a right-side perspective view of the service tool of FIG. 1 showing a cut utility line and a plug in an installed position;

FIG. 16 is a right-side perspective view of the service tool of FIG. 1 showing a cut and plugged utility line;

FIG. 17 is a side view of a plug configured for use with the service tool of FIG. 1;

FIG. 18 is a side cross-sectional view of the plug shown in FIG. 17 taken along line B-B;

FIG. 19 is a perspective view of a service tool for cutting and plugging a fluid line in accordance with one embodiment or aspect of the present disclosure;

FIG. 20 is an exploded perspective view of the service tool shown in FIG. 19;

FIG. 21 is a perspective view of the service tool of FIG. 19 shown installed on a utility line;

FIG. 22 is a perspective view of the service tool of FIG. 19 shown with an unclamped clamping mechanism;

FIG. 23 is a perspective view of the service tool of FIG. 19 shown with a clamped clamping mechanism;

FIG. 24 is a perspective view of the service tool of FIG. 19 shown during a cutting procedure of the service line;

FIG. 25A is a side view of the service tool shown in FIG. 24;

FIG. 25B is a cross-sectional view of the service tool shown in FIG. 25A taken along line C-C;

FIG. 26 is a perspective view of the service tool showing a cut portion of the utility line;

FIG. 27 is a perspective view of the service tool showing a plugging mechanism in a dispensing position;

FIG. 28A is a top view of the service tool shown in FIG. 27;

FIG. 28B is a cross-sectional view of the service tool shown in FIG. 28A taken along line D-D;

FIG. 28C is a cross-sectional view of the service tool with a plug or valve shown in a deployed position;

FIG. 29 is a perspective view of the service tool removed from a cut and plugged utility line;

FIG. 30 is a perspective view of a service tool for cutting and plugging a fluid line in accordance with one embodiment or aspect of the present disclosure;

FIG. 31 is an exploded perspective view of the service tool shown in FIG. 29;

FIG. 32A is a side view of the service tool shown in FIG. 30;

FIG. 32B is a side cross-sectional view of the service tool of FIG. 32A taken along line E-E;

FIG. 33 is a perspective view of the service tool prior to installation on a utility line;

FIG. 34 is a perspective view of the service tool installed on the utility line;

FIGS. 35-37 are side views of a cutting blade in various cutting positions relative to the utility line;

FIG. 38 is a side cross-sectional view of the service tool showing a plugging mechanism in a dispensing position;

FIG. 39 is a side cross-sectional view of the service tool showing a plug or valve in a deployed position via a first installation method;

FIG. 40 is a side cross-sectional view of the service tool showing a plug or valve in a deployed position via a second installation method;

FIG. 41 is a perspective view of the service tool removed from a cut and plugged utility line;

FIG. 42 is a perspective view of a service tool for cutting and plugging a fluid line in accordance with one embodiment or aspect of the present disclosure;

FIG. 43 is a perspective view of the service tool shown in FIG. 42 with the fluid line cut and a plugging mechanism in a deployment position;

FIG. 44 is a perspective view of a service tool for cutting and plugging a fluid line in accordance with one embodiment or aspect of the present disclosure; and

FIG. 45 is a perspective view of the service tool shown in FIG. 44 with the fluid line cut and a plugging mechanism in a deployment position.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to embodiments or aspects as they are oriented in the drawing figures. However, it is to be understood that embodiments or aspects may assume various alternative variations and step sequences, except where expressly specified to the contrary. It is also to be understood that the specific devices and processes illustrated in the attached drawings, and described in the following specification, are simply non-limiting exemplary embodiments or aspects. Hence, specific dimensions and other physical characteristics related to the embodiments or aspects of the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” As used in the specification and the claims, the singular form of “a,” “an,” and “the” include plural referents, such as unless the context clearly dictates otherwise. Additionally, Furthermore, as used herein, the terms “set” and “group” are intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. Further, the phrase “based on” is intended to mean “based at least partially on” unless explicitly stated otherwise. Further, the phrase “based on” may mean “in response to” and be indicative of a condition for automatically triggering a specified operation of an electronic device (e.g., a controller, a processor, a computing device, etc.) as appropriately referred to herein.

All numbers used in the specification and claims are to be understood as being modified in all instances by the term “about”. The terms “approximately”, “about”, and “substantially” mean a range of plus or minus ten percent of the stated value.

As used herein, the term “at least one of” is synonymous with “one or more of”. For example, the phrase “at least one of A, B, and C” means any one of A, B, and C, or any combination of any two or more of A, B, and C. For example, “at least one of A, B, and C” includes one or more of A alone; or one or more of B alone; or one or more of C alone; or one or more of A and one or more of B; or one or more of A and one or more of C; or one or more of B and one or more of C; or one or more of all of A, B, and C. Similarly, as used herein, the term “at least two of” is synonymous with “two or more of”. For example, the phrase “at least two of D, E, and F” means any combination of any two or more of D, E, and F. For example, “at least two of D, E, and F” includes one or more of D and one or more of E; or one or more of D and one or more of F; or one or more of E and one or more of F; or one or more of all of D, E, and F.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

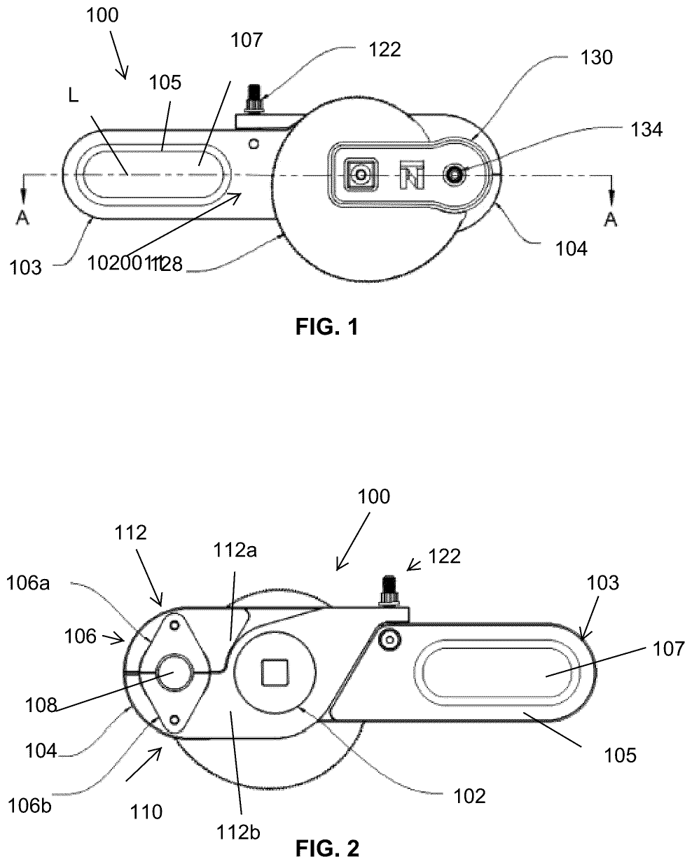

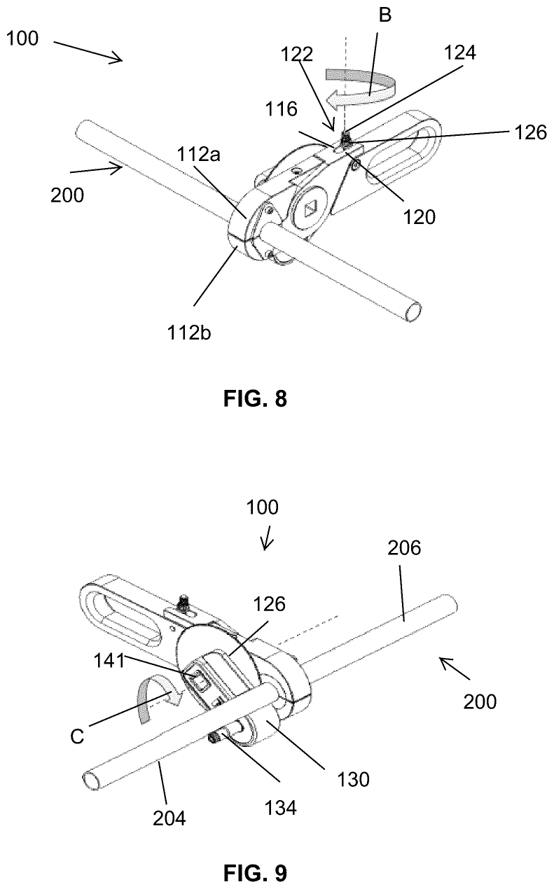

With reference to FIGS. 1-2, a tool 100 (hereinafter referred to as “tool 100”) for cutting and plugging a fluid line 200 (shown in FIG. 8) is shown in accordance with some non-limiting embodiments or aspects of the present disclosure. The fluid line 200 may be a water, gas, or other utility line configured for carrying fluid. The fluid line 200 may be configured for connecting a main line to a residential or commercial building. In some embodiments or aspects, the fluid line 200 may be an indoor plumbing line. As described in detail herein, the tool 100 is configured for cutting the fluid line 200 and displacing a first cut portion, such as a downstream portion connected to the residential or commercial building, of the fluid line 200. The tool 100 is further configured to plug the second cut portion, such as an upstream portion connected to the main line. In this manner, the repairs or maintenance can be carried on the fluid line 200 without having to turn off the supply to the main line. In this manner, repairs or maintenance on a single residential or commercial building do not interrupt the water supply of neighboring buildings because the main line can be active during repairs or maintenance.

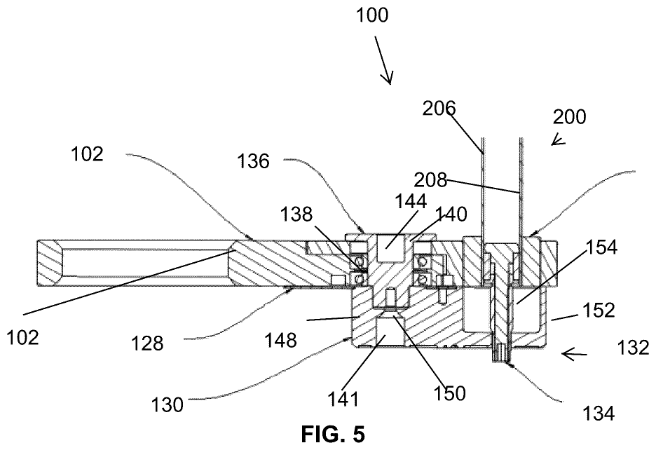

With reference to FIGS. 2, the tool 100 includes a body 102 having a receiving portion 104 configured to receive the fluid line 200 (shown in FIG. 5). In some embodiments or aspects, the receiving portion 104 extends in a direction that is substantially perpendicular to a longitudinal axis L of the service tool (shown in FIG. 1). The receiving portion 104 is sized to receive an outer circumference of the fluid line 200.

With reference to FIGS. 1-2, the body 102 has a handle 103 for holding the tool 100. The handle 103 may be connected to the body 102 or be monolithically formed with the body 102. In some embodiments or aspects, the handle 103 extends in a direction substantially parallel to a longitudinal axis L of the body. The handle 103 may have a holding portion 105 configured for being gripped by the user while using the tool 100. In some embodiments or aspects, an opening 107 may extend through the holding portion 105.

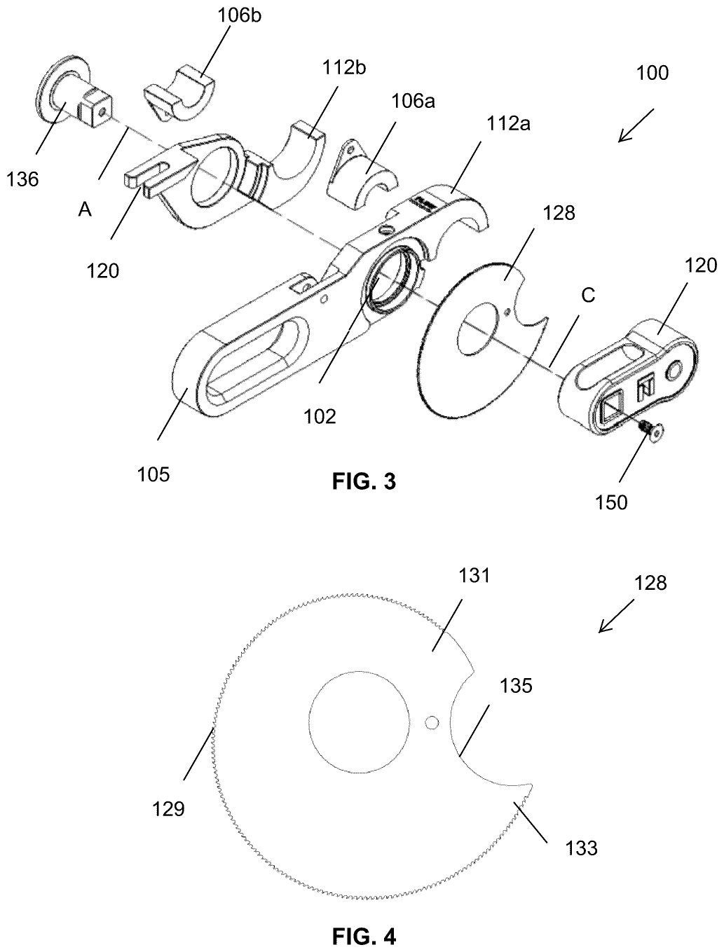

In some embodiments or aspects, and with reference to FIG. 3, the receiving portion 104 may have a sleeve 106 having a central opening 108 configured to receive the fluid line 200. The sleeve 106 is configured to support the fluid line 200 along a portion of the fluid line 200 that is inserted into the tool 100.

With reference to FIG. 3, the sleeve 106 may be removably connectable to the receiving portion 104. In this manner, a plurality of different sleeves 106 having different-sized central openings 108 can be connected to the receiving portion 104 in order to accommodate different-sized fluid lines 200. For example, a sleeve 106 having a 1″ central opening 108 may be connected to the body 102 of the tool 100 to service a fluid line 200 having a 1″ outer diameter. If service or maintenance is required on a fluid line 200 having a larger diameter, such as 1.5″, 2″, or other outer diameter, a sleeve 106 having an appropriately sized central opening 108 may be connected to the body 102. In some embodiments or aspects, the sleeve 106 is not required if the receiving portion 104 is appropriately sized to fit around an outer diameter of the fluid line 200.

With reference to FIGS. 2-3, the sleeve 106 may be split into two portions to allow the fluid line 200 to be inserted into the receiving portion 104. For example, the sleeve 106 may have a first sleeve portion 106a associated with a first portion of the body 102 and a second sleeve portion 106b associated with a second portion of the body 102. The first and second sleeve portions 106a, 106b may be movable relative to each other to permit insertion of the fluid line 200 into the central opening 108 of the sleeve 106. The first and second sleeve portion 106a, 106b can be clamped together after the fluid line 200 is inserted into the central opening 108.

With continued reference to FIG. 2, the tool 100 may have a clamping mechanism 110 movable relative to the body 102 and configured to clamp around at least a portion of an outer circumference of the fluid line 200 (shown in FIG. 5) when the fluid line 200 is received in the receiving portion 104, such as the central opening 108 of the sleeve 106. The clamping mechanism 110 has at least one jaw 112 movable relative to the body 102 between an open position (shown in FIG. 7) and a closed position (shown in FIG. 4). In the open position, the clamping mechanism 110 is configured to permit insertion of the tool 100 around the fluid line 200. For example, the at least one jaw 112 may be opened to widen the central opening 108 such that the tool 100 can be fitted around the fluid line 200. In the closed position, the clamping mechanism 110 is secured to be in close physical contact with the outer surface of the portion of the fluid line 200 that is received within the central opening 108. For example, the at least one jaw 112 may be closed to enclose the central opening 108 and clamp around at least the portion of the outer circumference of the fluid line 200. In some embodiments or aspects, the clamping mechanism 110 may have an over-center linkage mechanism configured to have an unlocked position, where the over-center linkage mechanism is arranged to allow the fluid line 200 to be freely inserted into or removed from the tool 100, and a locked position, where the over-center linkage mechanism is arranged to lock the fluid line 200 such that it cannot be removed from the tool 100.

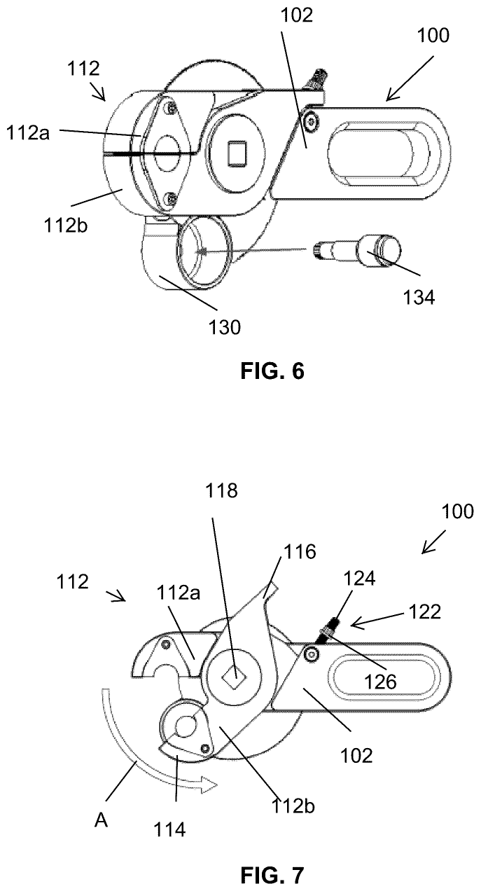

With reference to FIGS. 6-7, the at least one jaw 112 of the clamping mechanism 110 may be a first fixed jaw 112a and a second movable jaw 112b. The first fixed jaw 112a is fixed relative to the body 102 while the second movable jaw 112b is movable relative to the body 102 and the first fixed jaw 112a in a direction of arrow A. In some embodiments or aspects, the at least one jaw 112 may have a pair of movable jaws (not shown), both of which are movable relative to the body 102 and in opposite directions relative to each other.

With reference to FIG. 7, the second movable jaw 112b has a first end 114 configured for contacting the fluid line 200 and a second end 116 opposite the first end 114. The second movable jaw 112b may be pivotally connected to the body 102 at a first pivot point 118 such that the second movable jaw 112b is pivotable in the direction of arrow A relative to the body 102 and the first fixed jaw 112a about a pivot axis defined by the first pivot point 118.

With reference to FIG. 8, the second end 116 of the second movable jaw 112b has a slot 120 configured to engage a clamping device 122. In some embodiments or aspects, the clamping device 122 includes a threaded shaft 124 connected to the body 102. The threaded shaft 124 may be pivotally connected to the body 102 about a second pivot point 126 such that the threaded shaft 124 is pivotally movable relative to the body 102.

In order to secure the second movable jaw 112b relative to the body 102, the threaded shaft 124 is pivoted in a direction away from the second movable jaw 112b such that the second end 116 of the second movable jaw 112b can be moved to the closed position against the body 102 (FIG. 8). Once the second movable jaw 112b is in the closed position, the threaded shaft 124 is pivoted in a reverse direction toward the second movable jaw 112b such that the threaded shaft 124 is received in the slot 120 of the second movable jaw 112b. A nut 126 is provided on the threaded shaft 124 to clamp the second movable jaw 112b in the closed position between the nut 126 and the body 102 of the tool 100. The second movable jaw 112b can be unclamped by releasing the nut 126 and pivoting the threaded shaft 124 out of the slot 120.

With reference to FIGS. 3-4, the tool 100 includes a cutting blade 128 configured to engage an outer surface 202 of the fluid line 200 and cut through the fluid line 200. In some embodiments or aspects, the cutting blade 128 is rotatable relative to the body 102 about a cutting axis C. In order to cut the fluid line 200, the fluid line 200 is clamped in the receiving portion 104 using the clamping mechanism 110 and the cutting blade 128 is rotated about the cutting axis C.

With reference to FIG. 4, the cutting blade 128 has a plurality of cutting teeth 129 extending along at least a portion of an outer perimeter thereof. The cutting teeth 129 are configured to score and cut through the sidewall of the fluid line 200. The cutting blade 128 has an asymmetrical shape relative to the cutting axis C such that the cutting teeth 129 of the cutting blade 128 step and cut further into the fluid line 200 as the blade is rotated about the cutting axis C. The cutting blade 128 has a first end 131 that is configured to contact an outer surface of the fluid line 200, a second end 133 that is configured to cut through the fluid line 200 and a plug notch 135 between the first and second ends. The cutting blade 128 is configured to cut the fluid line 200 into a first cut portion 204 and a second cut portion 206 as the cutting blade 128 is rotated about the cutting axis C.

With reference to FIGS. 1 and 4, the tool 100 has a hub 130 associated with the body 102. The hub 130 is connected to the body 102 via a rotatable shaft 136 such that the hub 130 is rotatable relative to the body 102 with rotation of the rotatable shaft 136. The cutting blade 128 is also operatively connected to the rotatable shaft 136 such that the cutting blade 128 is also rotatable with rotation of the rotatable shaft 136.

With reference to FIG. 5, the hub 130 has a plugging mechanism 132 configured to displace the first cut portion 204 of the fluid line 200 and dispense a plug 134 into the opening of the second cut portion 206. The hub 130 is configured to contact the fluid line 200 as the body 102 of the tool 100 is rotated about the fluid line 200 to displace the first cut portion 204 of the fluid line 200 such that the plug 134 is aligned with the second cut portion 206. The rotatable shaft 136 may be rotatably supported within the body 102 by at least one bearing 138. The rotatable shaft 136 has an input drive 140 configured for connecting to a tool for rotating the rotatable shaft 136. In some embodiments or aspects, the input drive 140 may be a keyed hole 144 configured for receiving a corresponding protrusion 146 on the tool. The rotatable shaft 136 can be rotated about its rotation axis A (shown in FIG. 3) by engaging the keyed hole 144 of the input drive 140 with the protrusion 146 of the tool and rotating the tool. In some embodiments or aspects, the tool may be an impact gun or a wrench. The rotation axis A of the rotatable shaft 136 is coaxial with the cutting axis C of the cutting blade 128.

In some embodiments or aspects, the tool 100 may have an alignment mechanism configured for aligning the hub 130 with the cut portion of the fluid line 200 such that the plug 134 or valve is aligned with the opening of the cut portion of the fluid line 200 for easy insertion. The alignment mechanism may be a hard stop connected to the body 102 or the cutting blade 128 that limits the movement of the hub 130 and aligns the hub relative to the cut portion of the fluid line 200.

With continued reference to FIG. 5, the hub 130 has a first end 148 connected to the rotatable shaft 136 by a fastener 150 and a second end 152 offset from the first end 148 and the rotatable shaft 136. The first end 148 may have a second input drive 141 that corresponds to the input drive 140 on the rotatable shaft 136. The second end 152 of the hub 130 may have a plug chamber 154 for receiving the plug 134 (also shown in FIG. 6) or valve. The plug chamber 154 may be aligned with the plug notch 135 on the cutting blade 128. In some embodiments or aspects, the plug chamber 154 may be threaded such that the plug 134 can be threadably connected to the second end 152 of the hub 130.

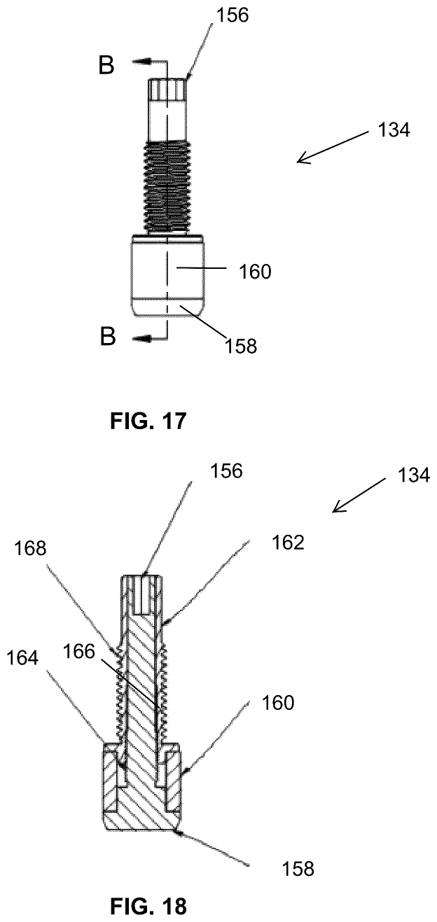

With reference to FIGS. 17 and 18, the plug 134 has an inner portion 156 having a plug end 158 with a seal 160 configured for engaging an inner sidewall 208 of the second cut portion 206 of the fluid line 200 (shown in FIG. 5). The plug 134 further has an outer portion 162 threadably connected to a shaft 164 of the inner portion 156 protruding from the plug end 158. In some embodiments or aspects, the plug 134 may have a conical shape such that the plug 134 acts as a mandrel to restore the second cut portion 206 of the fluid line 200 into a cylindrical shape. In some examples, the sidewall of the second cut portion 206 may be compressed or bent as the result of the cutting process, and the plug 134 can be configured to restore the sidewall of the second cut portion 206 to have the original cylindrical form.

The inner and outer portions 156, 162 are movable relative to each other such that the seal 160 is compressible between them. Compression of the seal 160 causes it to expand in a radially outward direction such that the seal 160 can engage the inner surface of the fluid line 200 to seal the fluid line 200. The outer portion 162 has first threads 166 on an interior thereof configured for threadably connecting to the shaft 164 of the inner portion 156. The outer portion 162 further has second threads 168 on an exterior thereof for threadably connecting to the plug chamber 154 of the hub 130 (shown in FIG. 6). A tool may be provided for driving the plug 134 out of the hub 130 and into the second cut portion 206 of the fluid line 200. The tool may be configured to engage the inner and outer portions 156, 162 of the plug so that the plug 134 is not tightened when driven into the second cut portion 206 of the fluid line 200.

Having described the structure of the tool 100, a method of using the tool 100 to cut and plug the fluid line 200 will now be described with reference to FIGS. 6-16. With reference to FIG. 6, prior to use of the tool 100, the plug 134 is loaded into the plugging mechanism 132 of the hub 130. For example, the plug 134 can be loaded by threadably engaging the second threads 168 on the outer portion of the plug 134 with the threads on the plug chamber 154 of the hub 130.

After loading the plug 134 into the plugging mechanism 132 of the hub 130, the clamping mechanism 110 is moved from the closed position to the open position. With reference to FIG. 7, with the clamping device 122 in an unclamped position, the second movable jaw 112b may be pivotally moved relative to the body 102 and the first jaw 112a in the direction of arrow A about the pivot axis defined by the first pivot point 118. Such movement opens the movable jaws 112a, 112b to permit insertion of the tool 100 around the fluid line 200.

With reference to FIG. 7, when the tool 100 is fitted around the fluid line 200, the second movable jaw 112b may be pivotally moved relative to the body 102 and the first jaw 112a in the direction of arrow B to close the jaws 112a, 112b around the fluid line 200. In order to secure the second movable jaw 112b relative to the body 102, the threaded shaft 124 of the clamping device 122 is pivoted in a direction away from the second movable jaw 112b such that the second end 116 of the second movable jaw 112b can be moved to the closed position against the body 102. Once the second movable jaw 112b is in the closed position, the threaded shaft 124 is pivoted in a reverse direction toward the second movable jaw 112b such that the threaded shaft 124 is received in the slot 120 of the second movable jaw 112b (shown in FIG. 8). The nut 126 on the threaded shaft 124 is tightened by rotating it in a direction of arrow C to clamp the second movable jaw 112b in the closed position between the nut 126 and the body 102 of the tool 100.

With reference to FIG. 9, the cutting blade 128 is rotated about the cutting axis C by engaging the input drive 140 on the rotatable shaft 136 (shown in FIG. 3) or the second input drive 141 on the hub 130 with the tool. Rotation of the cutting blade 128 about the cutting axis C cuts the fluid line 200 due to engagement between the cutting blade 128 and the outer surface of the fluid line 200.

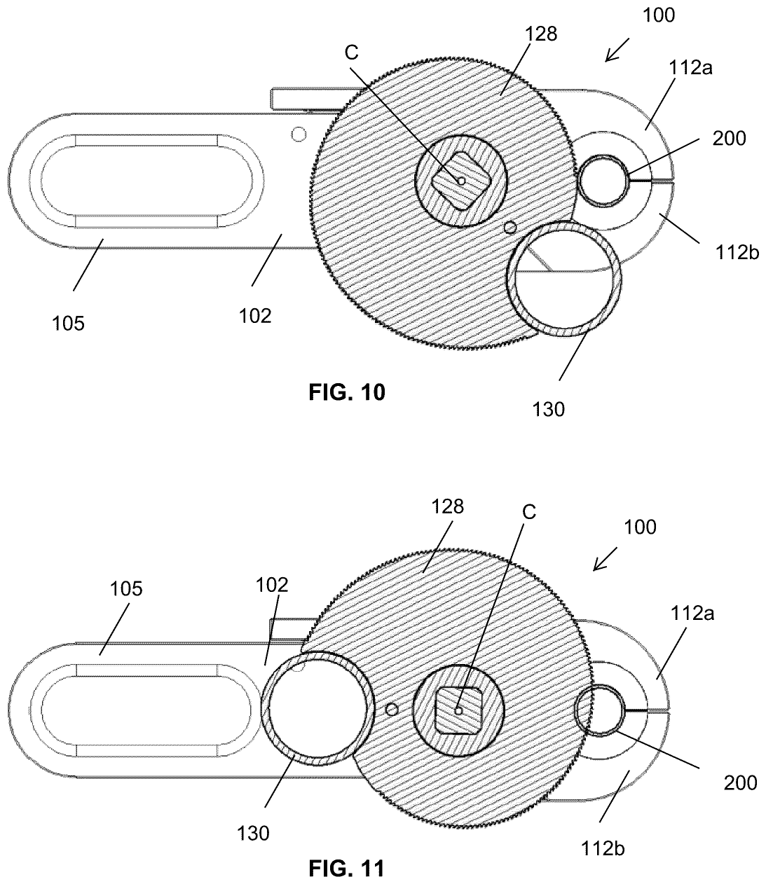

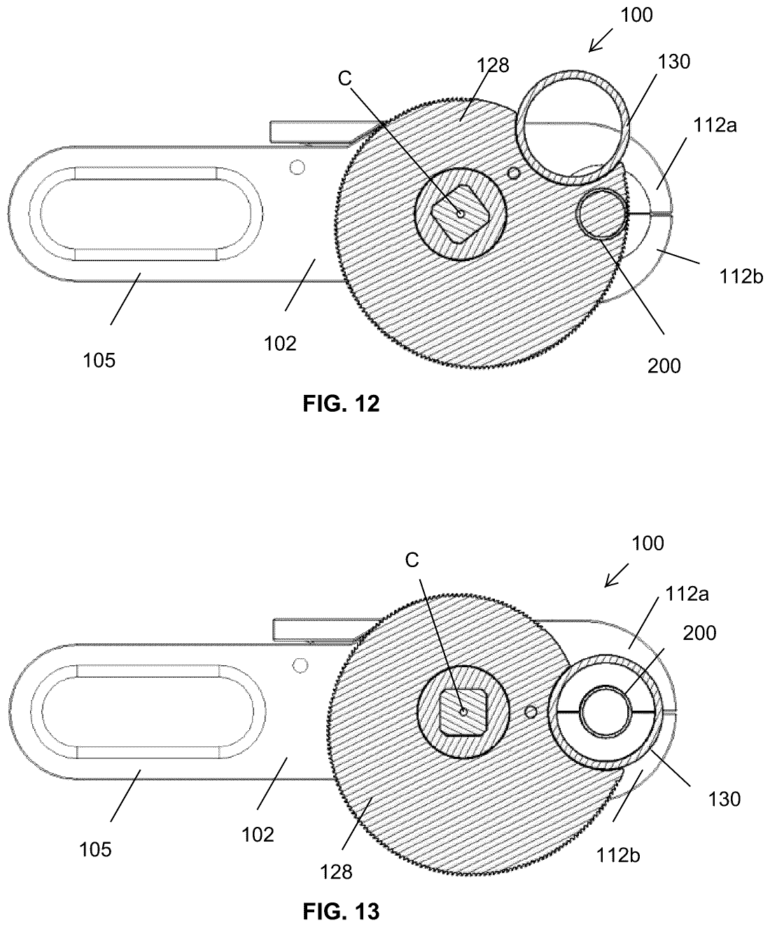

FIGS. 10-13 illustrate various positions of the cutting blade 128 relative to the fluid line 200 as the cutting blade 128 is rotated about the cutting axis C. Initially, as shown in FIG. 10, the cutting blade 128 contacts an outer surface 220 of the sidewall of the fluid line 200. As the cutting blade 128 is rotated about the cutting axis C, the cutting teeth 129 of the cutting blade 128 cut deeper into the fluid line (FIGS. 11-12). As the cutting blade 128 cuts through the sidewall of the fluid line 200, the hub 130 contacts the first cut portion 204 of the fluid line 200 to displace the first cut portion 204 as it is cut from the second cut portion 206 (shown in FIG. 9).

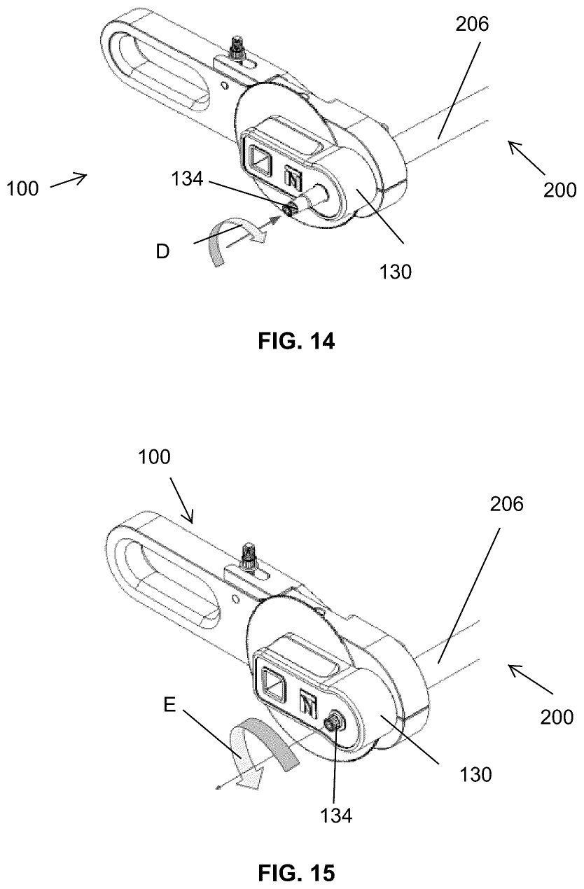

With reference to FIG. 14, the hub 130 is aligned with the second cut portion 206 such that the plug 134 can be unthreaded from the hub 130 and into the second cut portion 206 (see, also, FIG. 5). Specifically, the second threads 168 on the exterior of the outer portion 162 of the plug 134 (shown in FIGS. 17-18) can be disengaged from the plug chamber 154 of the hub 130 (shown in FIG. 5) by rotating the plug 134 in a direction of arrow D in FIG. 14. Such movement releases the plug 134 from the plug chamber 154 of the hub 130 and inserts the plug 134 into the second cut portion 206 of the fluid line 200. Additionally, insertion of the plug 134 into the second cut portion 206 restores the cylindricity of the second cut portion 206. During the cutting of the fluid line 200, the sidewall of the second cut portion 206 may be slightly deformed such that it is no longer cylindrical. By inserting the tapered plug 134 into the second cut portion 206, the sidewall of the second cut portion 206 can be restored to its original cylindrical shape.

With reference to FIG. 15, after the plug 134 is inserted into the second cut portion 206 of the fluid line 200, the plug 134 is tightened to seal against the inner sidewall 208 (shown in FIG. 5) of the second cut portion 206 by rotating the inner portion 156 of the plug 134 relative to the outer portion 162 in a direction of arrow E such that the seal 160 is compressed therebetween and expands in a radially outward direction to engage the inner sidewall 208 of the second cut portion 206 (see FIG. 5).

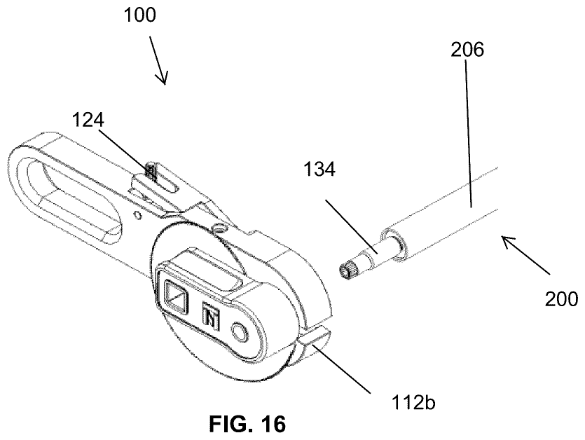

With reference to FIG. 16, the tool 100 can be disconnected from the second cut portion 206 by unthreading the nut 126 (shown in FIG. 8) from the threaded shaft 124 and releasing the second movable jaw 112b from the second cut portion 206 of the fluid line 200. In this manner, the open end of the second cut portion 206 remains plugged such that upstream water supply does not have to be shut off. In some embodiments or aspects, a valve may be installed over the plugged second cut portion 206 of the fluid line 200 to allow the plug 134 to be removed through the valve.

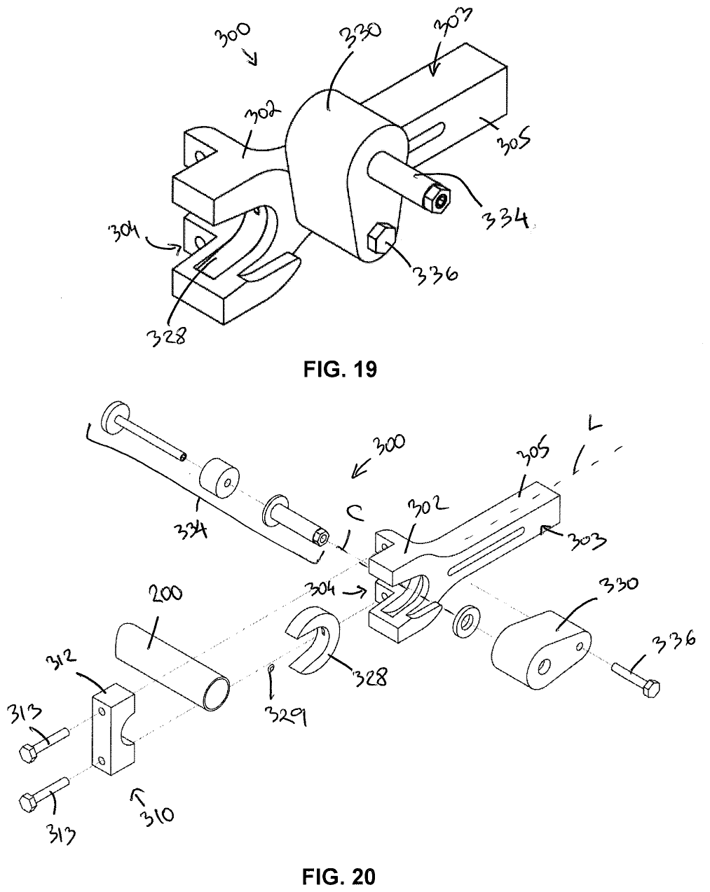

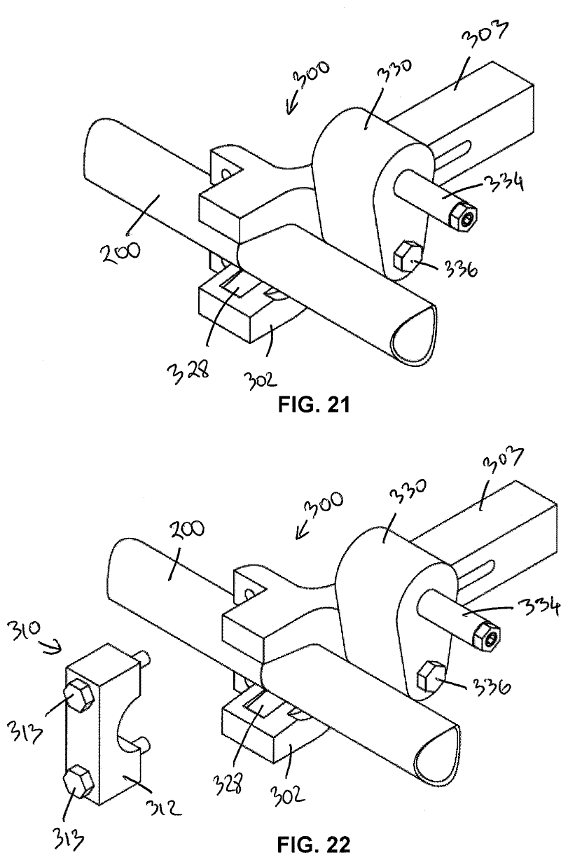

With reference to FIGS. 19-20, a tool 300 for cutting and plugging a fluid line 200 (shown in FIG. 21) is shown in accordance with another non-limiting embodiment or aspect of the present disclosure. As described in detail herein, the tool 300 is configured for cutting the fluid line 200 and displacing a first cut portion, such as a downstream portion connected to the residential or commercial building, of the fluid line 200. The tool 300 is further configured to plug the second cut portion, such as an upstream portion connected to the main line, with a plug or a valve, as discussed herein.

With reference to FIGS. 19-20, the tool 300 includes a body 302 having a receiving portion 304 configured to receive the fluid line 200 (shown in FIG. 21). In some embodiments or aspects, the receiving portion 304 extends in a direction that is substantially perpendicular to a longitudinal axis L of the service tool (shown in FIG. 20). The receiving portion 304 is sized to receive an outer circumference of the fluid line 200.

With continued reference to FIGS. 19-20, the body 302 has a handle 303 for holding the tool 300. The handle 303 may be connected to the body 302 or be monolithically formed with the body 302. In some embodiments or aspects, the handle 303 extends in a direction substantially parallel to a longitudinal axis L of the body. The handle 303 may have a holding portion 305 configured for being gripped by the user while using the tool 300.

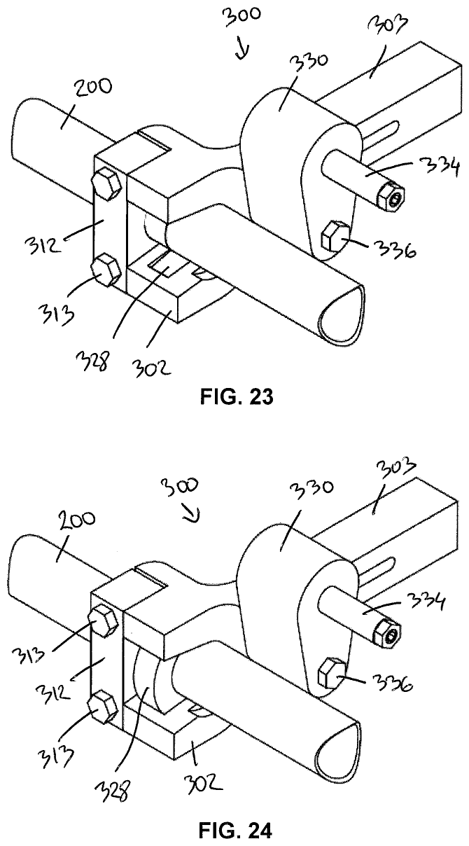

With continued reference to FIG. 20, the tool 300 may have a clamping mechanism 310 connectable to the body 302 and configured to clamp around at least a portion of an outer circumference of the fluid line 200 (shown in FIG. 21) when the fluid line 200 is received in the receiving portion 304. The clamping mechanism 310 has at least one clamp 312 that is removably connectable to the body 302 between an open position (shown in FIG. 21) and a closed position (shown in FIG. 23). In the open position, the clamping mechanism 310 is configured to permit insertion of the tool 300 around the fluid line 200. For example, the at least one clamp 312 may be removed from the body 302 such that the tool 300 can be fitted around the fluid line 200. In the closed position, the clamping mechanism 310 is secured to be in close physical contact with the outer surface of the portion of the fluid line 200 that is received within the body 302. For example, the at least one clamp 312 may be closed to clamp around at least the portion of the outer circumference of the fluid line 200. The at least one clamp 312 may be removably connectable to the body 302 via one or more fasteners 313.

In some embodiments or aspects, the clamping mechanism 310 may include at least one jaw, such as the first fixed jaw that is fixed relative to the body 302 and a second movable jaw is movable relative to the body 302 and the first fixed jaw, such as shown in FIG. 3. In some embodiments or aspects, the at least one jaw may have a pair of movable jaws, both of which are movable relative to the body 302 and in opposite directions relative to each other.

With continued reference to FIG. 20, the tool 300 includes a cutting assembly 328 configured to engage an outer surface 202 of the fluid line 200 and cut through the fluid line 200. In some embodiments or aspects, the cutting assembly 328 is rotatable relative to the body 302 about a cutting axis C. In order to cut the fluid line 200, the fluid line 200 is clamped using the clamping mechanism 310 and the cutting assembly 328 is rotated about the cutting axis C.

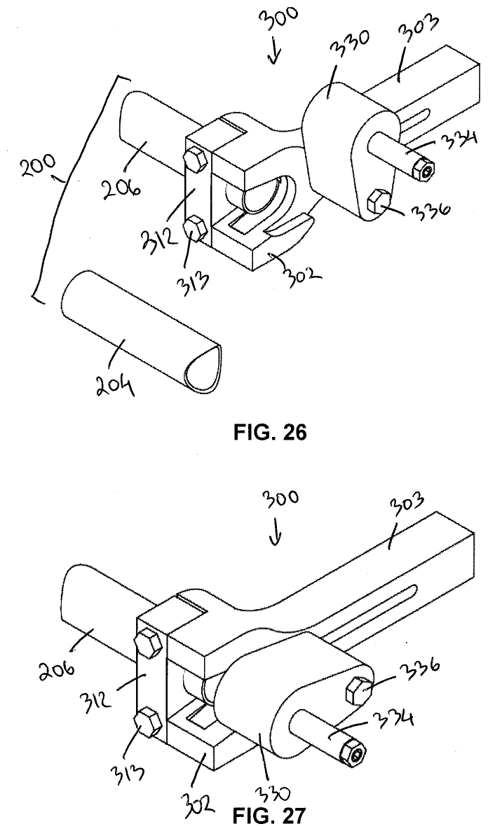

With reference to FIG. 20, the cutting assembly 328 is substantially C-shaped and has a cutter 329 connected thereto that is configured for contacting the outer surface 202 of the fluid line 200 when the fluid line 200 is clamped in the body 302 of the tool 300. The cutter 329 is configured to score and cut through the sidewall of the fluid line 200 as the cutting assembly 328 is rotated about the cutting axis C. The cutting assembly 328 is configured to cut the fluid line 200 into a first cut portion 204 and a second cut portion 206 (shown in FIG. 26) as the cutting assembly 328 is rotated about the cutting axis C.

With continued reference to FIG. 20, the tool 300 has a hub 330 associated with the body 302. The hub 330 is pivotally connected to the body 302 via a fastener 336 or other assembly for mechanically connecting the hub 330 to the body 302. The hub 330 has a plugging mechanism configured to displace the first cut portion 204 of the fluid line 200 and dispense a plug 334 or a valve into the opening of the second cut portion 206. In some embodiments or aspects, the plug 334 may be identical to the plug 134 described herein with reference to FIGS. 17-18. In other embodiments or aspects, the plug 334 may be a valve. The hub 330 is configured to contact the fluid line 200 as the body 302 of the tool 300 is rotated about the fluid line 200 to displace the first cut portion 204 of the fluid line 200 such that the plug 334 is aligned with the second cut portion 206.

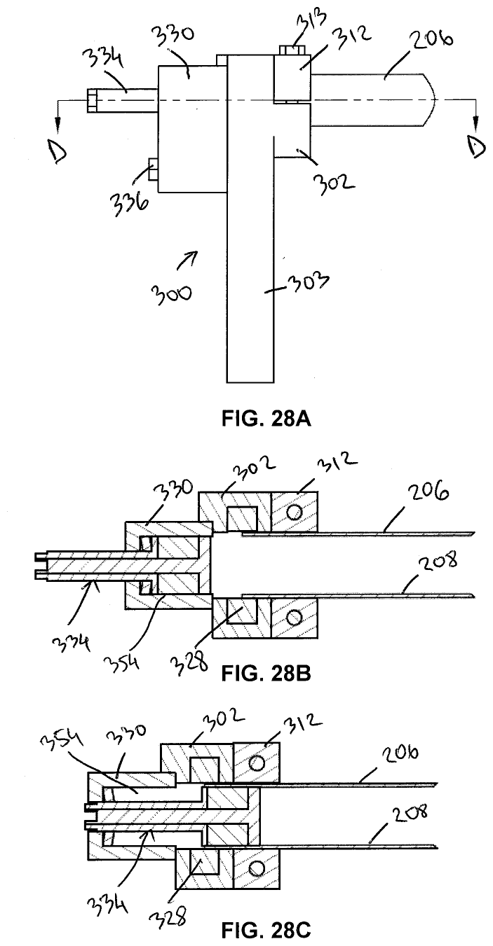

With continued reference to FIG. 20, the hub 330 has a first end 348 connected to the body 302 by the fastener 336 and a second end 352 offset from the first end 348. The second end 352 of the hub 330 may have a plug chamber 354 for receiving the plug 334 (also shown in FIGS. 28B-28C). In some embodiments or aspects, the plug chamber 354 may be threaded such that the plug 334 can be threadably connected to the second end 352 of the hub 330.

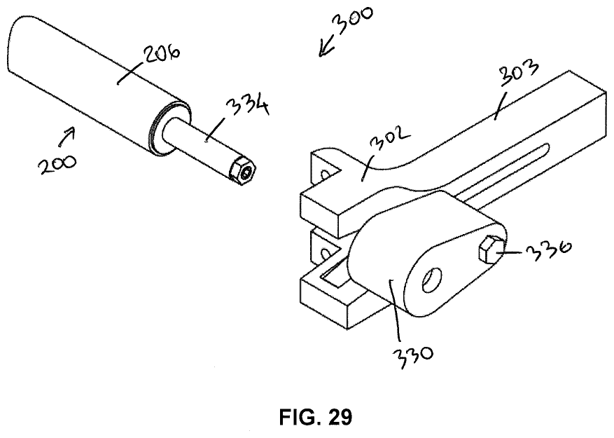

Having described the structure of the tool 300, a method of using the tool 300 to cut and plug the fluid line 200 will now be described with reference to FIGS. 21-29. With reference to FIG. 21, prior to use of the tool 300, the plug 334 or valve is loaded into the plugging mechanism 332 of the hub 330. For example, the plug 334 can be loaded by threadably engaging the plug 334 with the threads on the plug chamber 354 of the hub 330.

After loading the plug 334 into the plugging mechanism 332 of the hub 330, the body 302 of the tool 300 is fitted around the fluid line 200 and the clamping mechanism 310 is connected to enclose the fluid line 200 (see FIGS. 21-23).

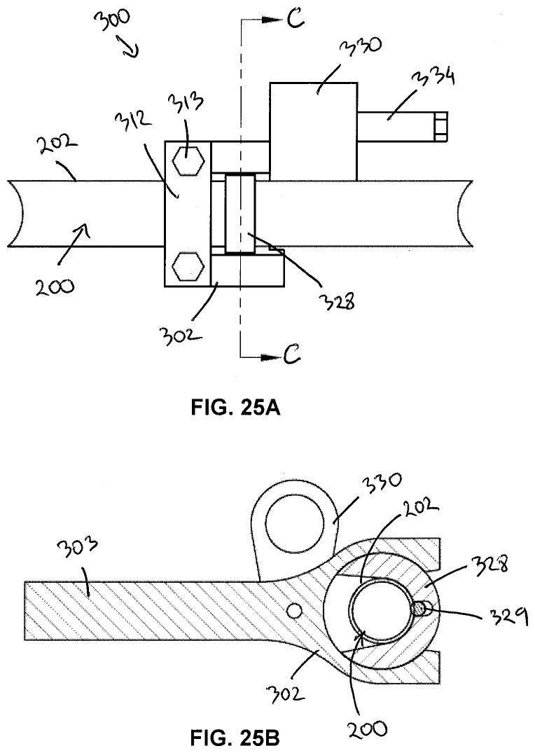

With reference to FIG. 24, the cutting assembly 328 is rotated about the cutting axis C. In some embodiments or aspects, the cutting assembly 328 may be manually rotated about the cutting axis C. In other embodiments or aspects, the cutting assembly 328 is rotated about the cutting axis C using a rotating mechanism, such as a motor drive. Rotation of the cutting assembly 328 about the cutting axis C cuts the fluid line 200 due to engagement between the cutter 329 and the outer surface 202 of the fluid line 200 (see FIGS. 25A-25B). As the cutting assembly 328 is rotated about the cutting axis C, the cutter 329 cuts deeper into the fluid line 200 such that it cuts through the sidewall of the fluid line 200 whereby a first cut portion 204 is cut from the second cut portion 206 (shown in FIG. 26).

With reference to FIG. 27, the hub 330 is aligned with the second cut portion 206 such that the plug 334 or valve can be unthreaded from the hub 330 and into the second cut portion 206 (see, also, FIGS. 28B-28C). After the plug 334 is inserted into the second cut portion 206 of the fluid line 200, the plug 334 is tightened to seal against the inner sidewall 208 (shown in FIG. 28C) of the second cut portion 206. The tool 300 can be disconnected from the second cut portion 206 by releasing the clamping mechanism 310 from the second cut portion 206 of the fluid line 200. In this manner, the open end of the second cut portion 206 remains plugged such that upstream water supply is uninterrupted.

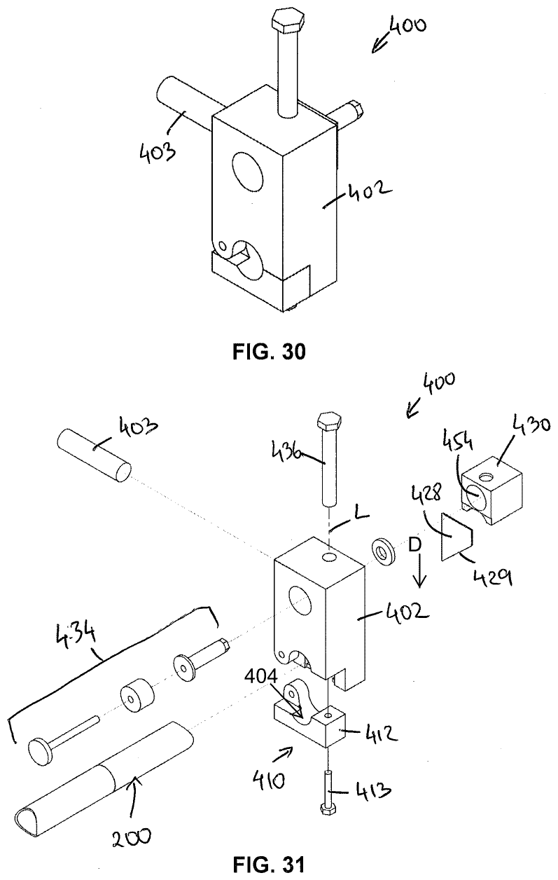

With reference to FIGS. 30-41, a tool 400 for cutting and plugging a fluid line 200 (shown in FIG. 31) is shown in accordance with another non-limiting embodiment or aspect of the present disclosure. As described in detail herein, the tool 400 is configured for cutting the fluid line 200 and displacing a first cut portion, such as a downstream portion connected to the residential or commercial building, of the fluid line 200. The tool 400 is further configured to plug the second cut portion, such as an upstream portion connected to the main line, with a plug or a valve, as discussed herein.

With reference to FIGS. 30-31, the tool 400 includes a body 402 having a receiving portion 404 configured to receive the fluid line 200 (shown in FIG. 31). In some embodiments or aspects, the receiving portion 404 extends in a direction that is substantially perpendicular to a longitudinal axis L of the service tool (shown in FIG. 31). The receiving portion 404 is sized to receive an outer circumference of the fluid line 200.

With continued reference to FIGS. 30-21, the body 402 has a handle 403 for holding the tool 400. The handle 403 may be connected to the body 402 or be monolithically formed with the body 402. In some embodiments or aspects, the handle 403 extends in a direction substantially perpendicular to a longitudinal axis L of the body 402.

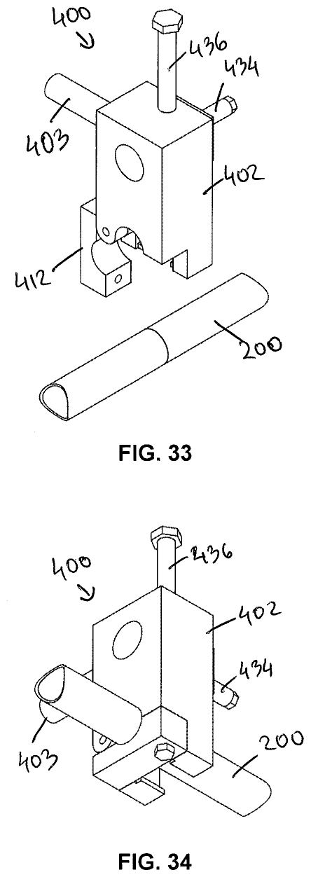

With continued reference to FIGS. 30-31, the tool 400 may have a clamping mechanism 410 connectable to the body 402 and configured to clamp around at least a portion of an outer circumference of the fluid line 200 (shown in FIG. 34) when the fluid line 200 is received in the receiving portion 404. The clamping mechanism 410 has at least one clamp 412 that is removably connectable to the body 402 between an open position (shown in FIG. 33) and a closed position (shown in FIG. 34). In the open position, the clamping mechanism 410 is configured to permit insertion of the tool 400 around the fluid line 200. For example, the at least one clamp 412 may be removed from the body 402 such that the tool 400 can be fitted around the fluid line 200. In the closed position, the clamping mechanism 410 is secured to be in close physical contact with the outer surface of the portion of the fluid line 200 that is received within the body 402. For example, the at least one clamp 412 may be closed to clamp around at least the portion of the outer circumference of the fluid line 200. The at least one clamp 412 may be removably connectable to the body 402 via one or more fasteners 413.

In some embodiments or aspects, the clamping mechanism 410 may include at least one jaw, such as the first fixed jaw that is fixed relative to the body 402 and a second movable jaw is movable relative to the body 402 and the first fixed jaw, such as shown in FIG. 3. In some embodiments or aspects, the at least one jaw may have a pair of movable jaws, both of which are movable relative to the body 402 and in opposite directions relative to each other.

With continued reference to FIG. 31, the tool 400 includes a cutting blade 428 configured to engage an outer surface 202 of the fluid line 200 and cut through the fluid line 200. In some embodiments or aspects, the cutting blade 428 is configured to translate linearly relative to the body 402 in a direction of arrow D. In order to cut the fluid line 200, the fluid line 200 is clamped using the clamping mechanism 410 and the cutting blade 428 is urged through the sidewall of the fluid line 200.

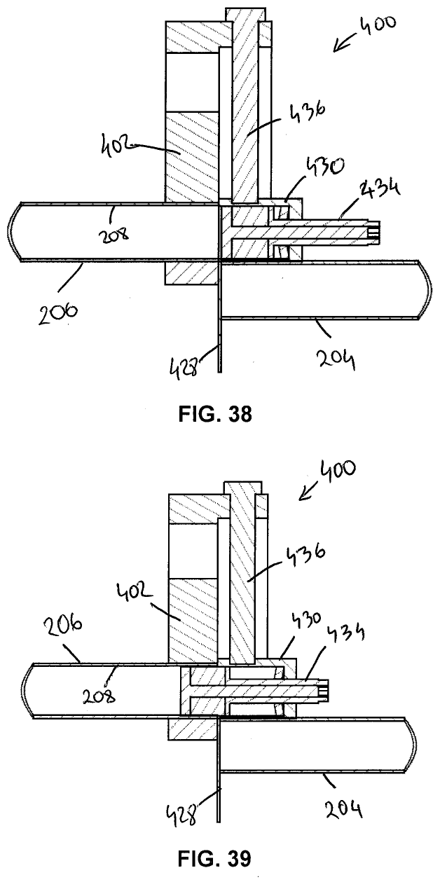

With reference to FIG. 31, the cutting blade 428 may have an angled cutting surface 429 that is configured for contacting the outer surface 202 of the fluid line 200 when the fluid line 200 is clamped in the body 402 of the tool 400. The cutting surface 429 is configured to cut through the sidewall of the fluid line 200 as the cutting blade 428 is moved relative to the body 402 and the fluid line in the direction of arrow D. In some embodiments or aspects, the cutting surface 429 may have one or more cutting teeth. The cutting blade 428 is configured to cut the fluid line 200 into a first cut portion 204 and a second cut portion 206 (shown in FIG. 38) as the cutting assembly 328 is moved linearly in the direction of arrow D.

With continued reference to FIG. 31, the tool 400 has a hub 430 associated with the body 402. The hub 430 is movably connected to the body 402 via a lead screw 436, which acts as a hub translation mechanism. The hub 430 has a plugging mechanism configured to displace the first cut portion 204 of the fluid line 200 and dispense a plug 434 or a valve into the opening of the second cut portion 206. In some embodiments or aspects, the plug 434 may be identical to the plug 134 described herein with reference to FIGS. 17-18. In other embodiments or aspects, the plug 434 may be a valve. The hub 430 is configured to translate linearly with movement of the cutting blade 428 to contact the fluid line 200 to displace the first cut portion 204 of the fluid line 200 such that the plug 434 is aligned with the second cut portion 206.

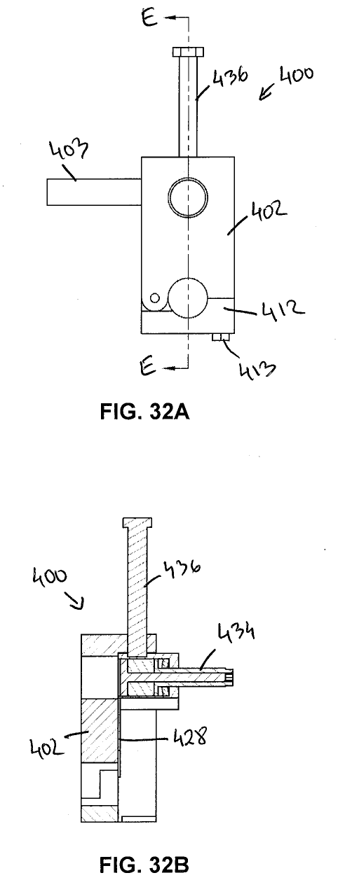

With continued reference to FIG. 31, the hub 430 has a plug chamber 454 for receiving the plug 434 (also shown in FIG. 32B). In some embodiments or aspects, the plug chamber 454 may be threaded such that the plug 434 can be threadably connected to the hub 430.

Having described the structure of the tool 400, a method of using the tool 400 to cut and plug the fluid line 200 will now be described with reference to FIGS. 33-41. With reference to FIGS. 32A-32B, prior to use of the tool 400, the plug 434 or valve is loaded into the plugging mechanism 432 of the hub 430. For example, the plug 434 can be loaded by threadably engaging the plug 434 with the threads on the plug chamber 354 of the hub 430.

After loading the plug 434 into the plugging mechanism 432 of the hub 430, the body 402 of the tool 400 is fitted around the fluid line 200 and the clamping mechanism 410 is connected to enclose the fluid line 200 (see FIGS. 33-34).

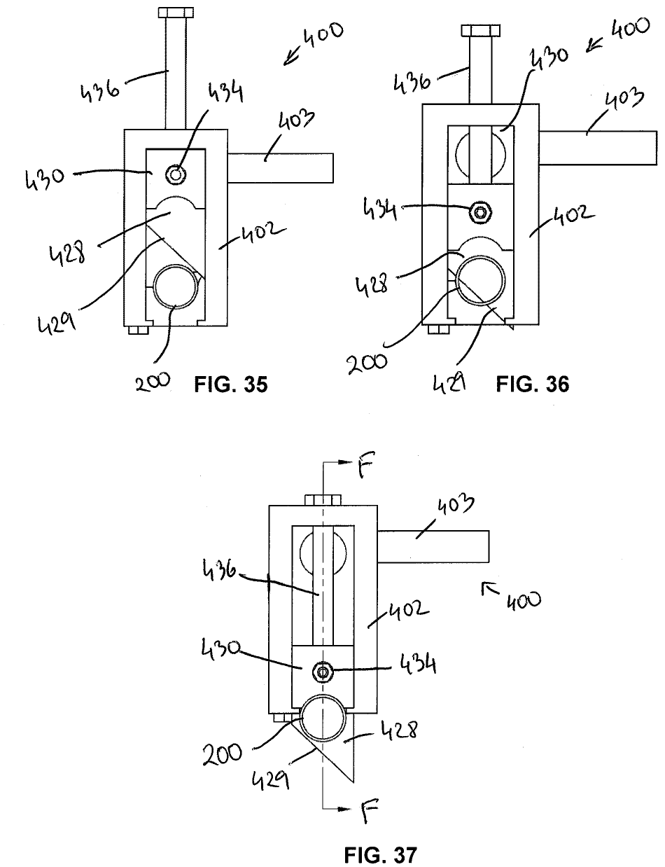

With reference to FIGS. 35-37, the cutting blade 428 is moved in the direction of arrow D, such as by rotating the lead screw 436 relative to the body 402. In some embodiments or aspects, the lead screw 436 may be manually rotated. In other embodiments or aspects, the lead screw 436 is rotated using a powered rotating mechanism, such as a motor drive. Movement of the cutting blade 428 in the direction of arrow D cuts through the sidewall of the fluid line 200 whereby a first cut portion 204 is cut from the second cut portion 206 (shown in FIG. 38).

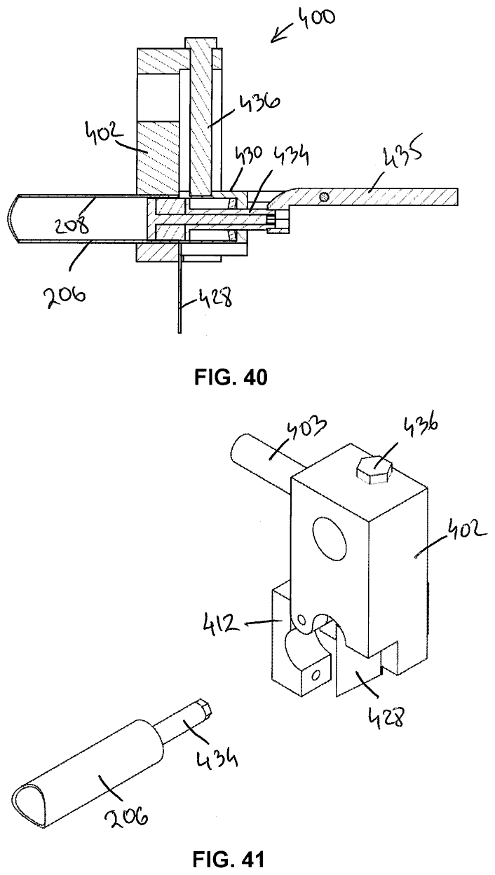

With reference to FIGS. 38-39, the hub 430 is aligned with the second cut portion 206 such that the plug 434 or valve can be unthreaded from the hub 430 and into the second cut portion 206. After the plug 434 is inserted into the second cut portion 206 of the fluid line 200, the plug 434 is tightened to seal against the inner sidewall 208 (shown in FIG. 40) of the second cut portion 206 using a tool 435. As shown in FIG. 41, the tool 400 can be disconnected from the second cut portion 206 by releasing the clamping mechanism 410 from the second cut portion 206 of the fluid line 200. In this manner, the open end of the second cut portion 206 remains plugged such that upstream water supply is uninterrupted.

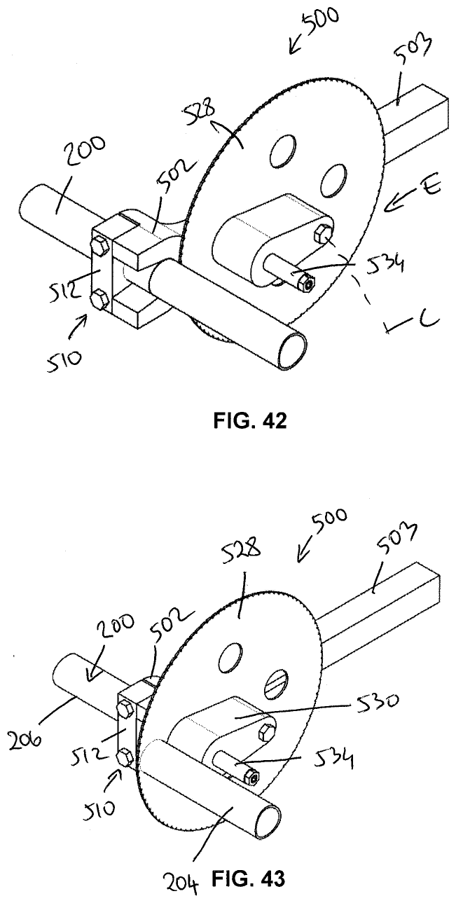

With reference to FIGS. 42-45, two tools 500 for cutting and plugging a fluid line 200 are shown in accordance with additional non-limiting embodiments or aspects of the present disclosure. As described in detail herein, the tools 500 shown in FIGS. 42-45 are configured for cutting the fluid line 200 and displacing a first cut portion, such as a downstream portion connected to the residential or commercial building, of the fluid line 200. The tools 500 are further configured to plug the second cut portion, such as an upstream portion connected to the main line, with a plug or a valve, as discussed herein.

With reference to FIGS. 42-45, each tool 500 includes a body 502 having a receiving portion 504 configured to receive the fluid line 200. The body 502 has a handle 503 for holding the tool 500. The tool 500 further may have a clamping mechanism 510 connectable to the body 502 and configured to clamp around at least a portion of an outer circumference of the fluid line 200 when the fluid line 200 is received in the receiving portion 504. The body 502, the handle 503, and the clamping mechanism 510 may be substantially similar or identical to the body 302, the, handle 303, and the clamping mechanism 310 described herein with reference to FIGS. 19-20.

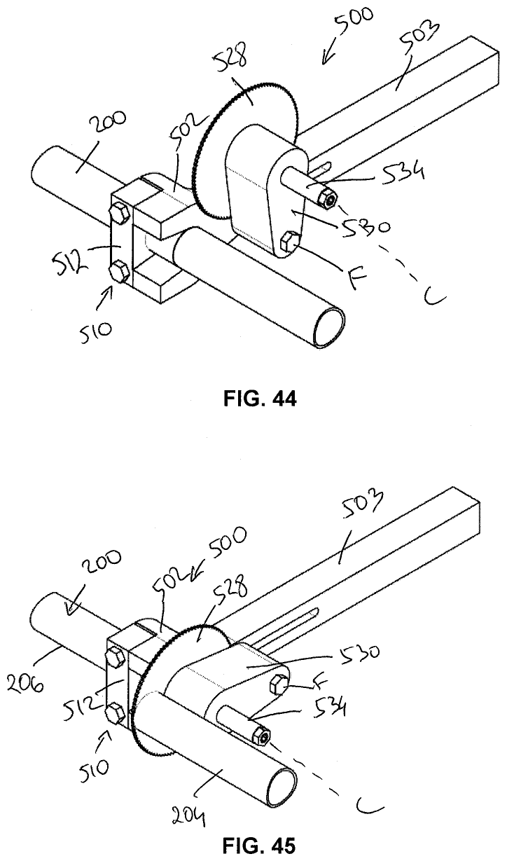

With continued reference to FIGS. 42-45, each tool 500 further includes a cutting blade 528 configured to engage an outer surface 202 of the fluid line 200 and cut through the fluid line 200. In some embodiments or aspects, such as shown in FIGS. 42-43, the cutting blade 528 is configured to translate linearly relative to the body 502 in a direction of arrow E while rotating about a cutting axis C. In other embodiments or aspects, such as shown in FIGS. 44-45, the cutting blade 528 is configured to pivot relative to the body 502 about a pivot point F while rotating about a cutting axis C. In order to cut the fluid line 200, the fluid line 200 is clamped using the clamping mechanism 510 and the cutting blade 528 is urged through the sidewall of the fluid line 200.

With continued reference to FIGS. 42-45, each tool 500 has a hub 530 associated with the body 502. The hub 530 has a plugging mechanism 532 configured to displace the first cut portion 204 of the fluid line 200 and dispense a plug 534 or a valve into the opening of the second cut portion 206 in a similar manner as the hub 330 and plugging mechanism 332 described herein with reference to FIGS. 19-20. As shown in FIGS. 42-43, the cutting blade 528 has a plurality of openings 529 that can be aligned with the hub 530 such that the plug 534 or valve can be inserted through the opening 529.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, many of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A service tool for cutting and plugging a fluid line, the service tool comprising:
a body having a receiving portion configured to receive the fluid line;
a clamping mechanism movable relative to the body and configured to clamp around at least a portion of an outer circumference of the fluid line when the fluid line is received in the receiving portion;
a cutting blade configured to engage the fluid line and cut the fluid line into a first cut portion and a second cut portion; and
a hub associated with the body, the hub comprising a plugging mechanism configured to dispense a plug or a valve into the second cut portion of the fluid line.

2. The service tool according to claim 1, wherein the cutting blade is configured to cut the fluid line into the first cut portion and the second cut portion via a rotational movement of the cutting blade relative to the body about a cutting axis.

3. The service tool according to claim 1, wherein the cutting blade is configured to cut the fluid line into the first cut portion and the second cut portion via a translational movement of the cutting blade relative to the body.

4. The service tool according to claim 1, wherein the cutting blade is configured to cut the fluid line into the first cut portion and the second cut portion via a rotational movement of the cutting blade relative to the fluid line about a cutting axis.

5. The service tool according to claim 1, wherein the cutting blade is configured to cut the fluid line into the first cut portion and the second cut portion via a reciprocal linear movement of the cutting blade relative to the fluid line.

6. The service tool according to claim 1, wherein the clamping mechanism comprises at least one jaw movable relative to the body between an open position and a closed position.

7. The service tool according to claim 6, wherein, in the closed position, the at least one jaw is configured to clamp around at least the portion of the outer circumference of the fluid line.

8. The service tool according to claim 6, wherein the at least one jaw is removably connectable to the body via a connecting element.

9. The service tool according to claim 1, further comprising a handle connected to the body, wherein the handle extends in a direction substantially perpendicular to a longitudinal axis of the receiving portion.

10. The service tool according to claim 1, wherein the hub is rotatable relative to the body about a pivot point.

11. The service tool according to claim 1, wherein the hub is translatable relative to the body via a hub translation mechanism.

12. The service tool according to claim 11, wherein the hub translation mechanism is a lead screw, a spring, or a lever.

13. The service tool according to claim 1, further comprising an input drive configured to move the cutting blade relative to the body.

14. The service tool according to claim 13, wherein the input drive is a keyed drive configured for receiving a corresponding input tool.

15. The service tool according to claim 1, wherein the hub is configured to contact the fluid line as the cutting blade is rotated about the cutting axis or translated relative to the body to displace the first cut portion of the fluid line such that the plug chamber is aligned with the second cut portion of the fluid line.

16. The service tool according to claim 1, wherein the plugging mechanism comprises a plug chamber configured to receive the plug or the valve.

17. The service tool according to claim 16, further comprising the plug or the valve disposed in the plug chamber of the plugging mechanism.

18. The service tool according to claim 17, wherein the plug or the valve is threadably or slidably received within the plug chamber.

19. The service tool according to claim 17, wherein the plug comprises an inner portion having a plug end with a seal configured for engaging an inner sidewall of the second cut portion of the fluid line and an outer portion threadably connected to a shaft of the inner portion protruding from the plug end.

20. The service tool according to claim 19, wherein the outer portion has first threads on an interior thereof configured for threadably connecting to the shaft of the inner portion and second threads on an exterior thereof for threadably connecting to the plug chamber of the plug mechanism.
